(19) United States
(12) Patent Application Publication
(10) Pub. No.: US 2018/0247553 A1
(43) Pub. Date: Aug. 30, 2018

(54) INFORMATION PROCESSING DEVICE, NON-TRANSITORY COMPUTER PROGRAM PRODUCT, AND INFORMATION PROCESSING SYSTEM

(71) Applicants: Noboru UEMURA, Kanagawa (JP); Chieko TEZUKA, Kanagawa (JP); Masaki UEMURA, Saitama (JP)

(72) Inventors: Noboru UEMURA, Kanagawa (JP); Chieko TEZUKA, Kanagawa (JP); Masaki UEMURA, Saitama (JP)

(73) Assignee: Ricoh Company, Ltd., Tokyo (JP)

(21) Appl. No.: 15/897,492

(22) Filed: Feb. 15, 2018

(30) Foreign Application Priority Data
Feb. 27, 2017 (JP) 2017-035164

(51) Int. Cl. G09B 7/06

(52) U.S. Cl. CPC G09B 7/06

(57) ABSTRACT

There is provided an information processing device for creating a data item of an answer sheet, wherein the answer sheet is used to select an answer to a question from a plurality of choices, the information processing device including a program which causes a processor to execute: creating the data item of the answer sheet including an answer field for each question, based on a number of a first choices that are answer candidates to the question and a number of second choices that are choices other than the answer candidates to the question, wherein the answer field for each question is arranged by inserting the second choices into positions, each of the positions being adjacent to the corresponding first choice of the first choices; and creating data items of respective answer sheets by changing the insertion positions of the second choices for the same question.

### BACKGROUND OF THE INVENTION

### 1. Field of the Invention

The present invention relates to an information processing device, a computer program product, an information processing system, and an information processing method.

### 2. Description of the Related Art

Marksheets are often used, for example, in tests where a question is to be answered by selecting a choice from among multiple choices for the question. A mark sheet may also be called an optical mark recognition (OMR) sheet, a bubble sheet, etc. It has been known that, in a test using such a mark sheet, cheating tends to occur.

In a test system in which a predetermined number of examination questions is to be provided to each of a plurality of examinees, it has been known to prevent cheating by providing, to each of the plurality of examinees, a set (group) of a predetermined number of examination questions. Here, the order of the predetermined number of examination questions of one set is different from order of the predetermined number of examination questions of another set (cf. Patent Document 1 (Japanese Unexamined Patent Publication No. 2002-297786), for example).

In a test in which a marksheet is used, by making the examination questions to be different in order among neighboring examinees, it has been made difficult to conduct fraudulent acts, such as cheating. However, a task is required to prepare a plurality of examination sheets with examination questions that are different in order, and a creator of the examination sheets may be required to spend time and effort on preparation. Note that, not only for tests using the mark sheets, but also for electronic voting and questionnaires using marksheets, a mechanism is required that is for protecting respondents from fraudulent acts, such as a furtive glance, from the perspective of privacy protection.

There is a need for an information processing device with which an answer sheet can be provided in which answers to questions made by a respondent are difficult to find by cheating by another respondent.

### SUMMARY OF THE INVENTION

According to an aspect of the present invention, there is provided an information processing device for creating a data item of an answer sheet, wherein the answer sheet is used for a respondent to select an answer to a question from a plurality of choices, the information processing device including a processor; and a memory that stores a program which causes the processor to execute the following steps: creating the data item of the answer sheet including an answer field for each question, based on a number of a first choices that are answer candidates to the question and a number of one or more second choices that are choices other than the answer candidates to the question, wherein the answer field for each question is arranged by inserting the one or more second choices in one or more positions, each one or two of the one or more positions being adjacent to the corresponding first choice of the first choices; and creating one or more data items of respective one or more answer sheets by changing the one or more insertion positions of the one or more second choices for the same question.

According to another aspect of the present invention, there is provided a non-transitory computer program product for being executed on a computer, including computer readable program that causes the computer to creating a data item of an answer sheet including an answer field for each question, based on a number of a first choices that are answer candidates to the question and a number of one or more second choices that are choices other than the answer candidates to the question, wherein the answer field for each question is arranged by inserting the one or more second choices in one or more positions, each one or two of the one or more positions being adjacent to the corresponding first choice of the first choices; and creating one or more data items of respective one or more answer sheets by changing the one or more insertion positions of the one or more second choices for the same question.

According to another aspect of the present invention, there is provided an information processing system including an information processing device and a printing apparatus, the information processing device including a processor; and a memory that stores a program which causes the processor to execute the following steps: creating a data item of an answer sheet including an answer field for each question, based on a number of a first choices that are answer candidates to the question and a number of one or more second choices that are choices other than the answer candidates to the question, wherein the answer field for each question is arranged by inserting the one or more second choices in one or more positions, each one or two of the one or more positions being adjacent to the corresponding first choice of the first choices; and creating one or more data items of respective one or more answer sheets by changing the one or more insertion positions of the one or more second choices for the same question,

wherein the printing apparatus comprising a print engine that prints the answer sheets based on the created data items of the answer sheets.

According to an embodiment of the present invention, there can be provided an information processing device with which an answer sheet can be provided in which answers to questions made by a respondent are difficult to find by fraudulent acts by another respondent.

Other objects, features and advantages of the present invention will become more apparent from the following detailed description when read in conjunction with the accompanying drawings.

### BRIEF DESCRIPTION OF THE DRAWINGS

FIG. 1 is a diagram illustrating an example of a configuration of an information processing system according to an embodiment;

FIG. 2 is a diagram illustrating a hardware configuration of an example of a computer;

FIG. 3 is a diagram illustrating a hardware configuration of an example of an image forming apparatus according to the embodiment;

FIG. 4 is a diagram illustrating processing blocks of an example of an information processing device according to the embodiment;

FIG. 5A is a diagram illustrating an image of examples of an answer sheet;

FIG. 5B is a diagram illustrating an image of examples of a correct answer sheet;

FIG. 6A is an example of an answer mark field (pattern A) according to the embodiment;

FIG. 6B is an example of an answer mark field (pattern B) according to the embodiment;

FIG. 7 is a flowchart of an example of a process executed by, the information processing system according to the embodiment;

FIG. 8 is a flowchart of an example of a process of creating an answer sheet and a correct answer sheet;

FIG. 9 is a diagram illustrating an image of an example of a condition setup screen;

FIG. 10 is a diagram illustrating an image of an example of the condition setup screen on which an answer sheet preview is displayed;

FIG. 11 is a flowchart illustrating an example of a process of a method for creating the answer mark field including dummy choices (version 1);

FIG. 12 is a diagram illustrating an image of an example of patterns of the answer mark field that are stored depending on a number of choices and a number of dummy choices;

FIG. 13 is a flowchart illustrating an example of a process of a method for creating the answer mark field including dummy choices (version 2);

FIG. 14 is a flowchart illustrating an example of a process of a method for creating the answer mark field including dummy choices (version 3);

FIG. 15 is a diagram illustrating examples of patterns of the answer sheet that are stored depending on the number of choices and the number of dummy choices;

FIG. 16 is a flowchart illustrating an example of a process of a method for creating the answer mark field including dummy choices (version 4);

FIG. 17 is a flowchart of an example of a process of correct answer data registration;

FIG. 18 is a diagram illustrating an image of an example of a process of registering, based on correct answers marked in one answer sheet, correct answer data for another answer sheet pattern;

FIG. 19 is a flowchart of an example of a process of answer data registration;

FIG. 20 is a flowchart of an example of a scoring process; and

FIG. 21 is a diagram illustrating a configuration of another example of the information processing system according to the embodiment.

### DETAILED DESCRIPTION OF THE PREFERRED EMBODIMENTS

In the following, an embodiment of the present invention is described by referring to the drawings. In the following embodiment, a test is exemplified in which a choice is selected from a plurality of choices to answer. However, the embodiment is not limited to the test. For example, the embodiment can be applied to various answering methods in which a choice is selected from a plurality of choices to answer, such as a questionnaire, electronic voting, and an inspection.

<System Configuration>

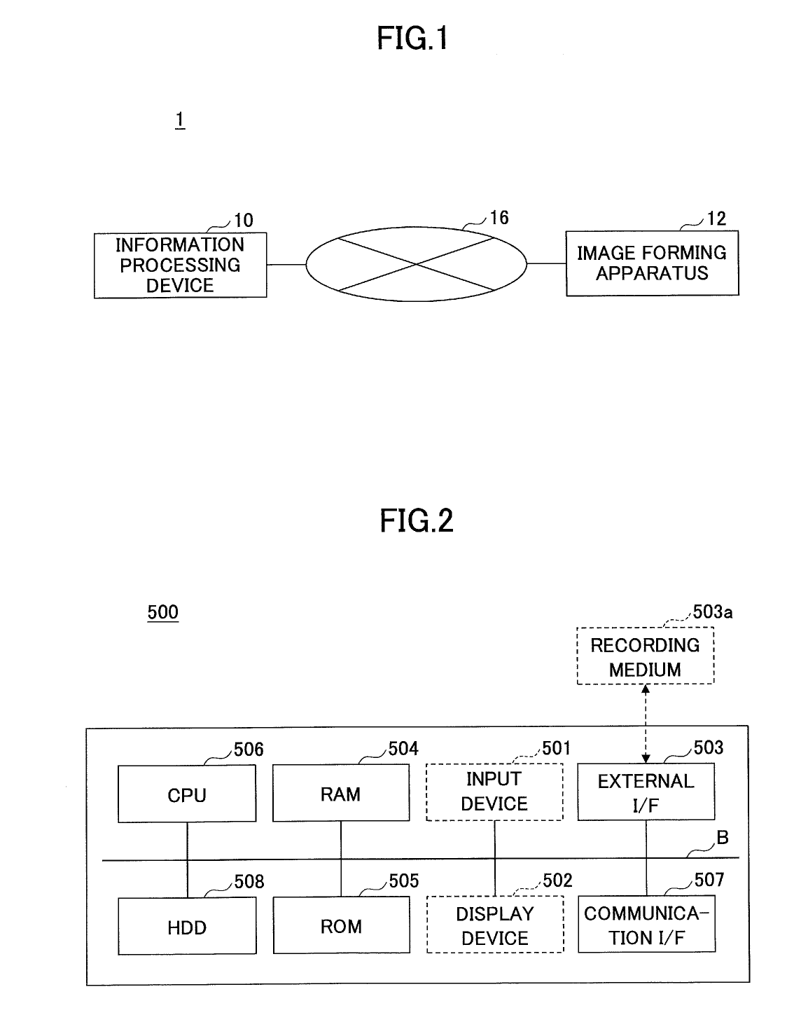

FIG. 1 is a diagram illustrating a configuration of an example of an information processing system according to the embodiment. In the information processing system 1 of FIG. 1, an information processing device 10 and an image forming apparatus 12 are coupled to each other through a network 16, such as the Internet or a local area network (LAN).

The information processing device 10 is, for example, a device, such as a personal computer (PC), a smartphone, or a cellular phone, that is operated by a teacher. The teacher is an example of an operator that prepares a test, and that performs scoring after the test. Using application software (which is simply referred to as “application,” hereinafter) installed in the information processing device 10, a teacher prepares a test and performs scoring after the test. The preparation of the test performed by the teacher includes a task of creating an answer sheet.

The image forming apparatus 12 is an electronic device for scanning and printing, such as a multifunction peripheral. The image forming apparatus 12 prints print data received from the information processing device 10. The image forming apparatus 12 transmits, to the information processing device 10, scan data obtained by scanning. For example, a teacher prints a question sheet and an answer sheet using the image forming apparatus 12. After the test, the teacher scans the answer sheet collected from a student using the image forming apparatus 12, and the teacher operates the image forming apparatus 12 to transmit the scan data to the information processing device 10. The information processing device 10 performs a process of preparing a test, such as creation of question sheet data, and a process of scoring after the test, as described below.

Note that the configuration of the information processing system 1 of FIG. 1 is an example, and there can be various system configuration examples depending on applications and purposes. For example, in the information processing system 1, the image forming apparatus 12 may be formed of a plurality of devices. For example, an image forming apparatus 12 for scanning may be different from an image forming apparatus 12 for printing. Additionally, the information processing device 10 may be formed of a plurality of devices.

<Hardware Configuration>

<<Computer>>

The information processing device 10 of FIG. 1 is implemented, for example, by a computer provided with a hardware configuration illustrated in FIG. 2.

FIG. 2 is a diagram illustrating a hardware configuration of an example of a computer. The computer 500 depicted in FIG. 2 is provided with an input device 501; a display device 502; an external interface (I/F) 503; a random access memory (RAM) 504; a read-only memory (ROM) 505; a central processing unit (CPU) 506; a communication I/F 507; a hard disc drive (HDD) 508, etc., which are mutually coupled to each other through a bus B. Here, the input device 501 and the display device 502 may be configured to be detachable; and, if it is necessary, the input device 501 and the display device 502 may be coupled to the computer 500 to be used.

The input device 501 includes a keyboard, a mouse, a touch panel, etc. The input device 501 is used by an operator to input operation signals. The display device 502 includes a display, etc. The display device 502 displays a processing result by the computer 500.

The communication I/F 507 is an interface for coupling the computer 500 to various types of networks. The computer 500 is capable of executing data communication through the communication I/F 507.

The HDD 508 is an example of a non-volatile storage device storing a program and data. As the program and the data stored in the HDD 508, for example, there are an operating system (OS) that is system software for controlling the entire computer 500, an application that provides various functions on the OS, etc. Instead of the HDD 508, the computer 500 may use a drive device (e.g., a solid state drive: SSD) that uses a flash memory as a storage medium.

The external I/F 503 is an interface with an external device. Examples of the external device include a recording medium 503a, etc. The computer 500 is capable of reading out data from the recording medium 503a through the external I/F and/or writing data in the recording medium 503a through the external I/F 503. As examples of the recording medium 503a, there are a flexible disk, a compact disc (CD), a digital versatile disk (DVD), a Secure Digital (SD) memory card, a universal serial bus (USB) memory, etc.

The ROM 505 is an example of a non-volatile semiconductor memory (storage device) that is capable of retaining a program and data, even if a power supply is turned off. The ROM 505 stores a program and data, such as a basic input/output system (BIOS) that is executed during activation of the computer 500, an OS configuration, and a network configuration. The RAM 504 is an example of a volatile semiconductor memory (storage device) that is capable of temporarily retaining a program and data.

The CPU 506 is a processing device (which is also referred to as a processor or a processing circuit) implementing control and functions of the entire computer 500 by reading out a program and data from a storage device, such as the ROM 505 and the HDD 508, onto the RAM 504 and by executing one or more processes. For example, by the hardware configuration of the computer 500 depicted in FIG. 2, the information processing device 10 can implement various types of processes, such as those described below.

<<Image Forming Apparatus>>

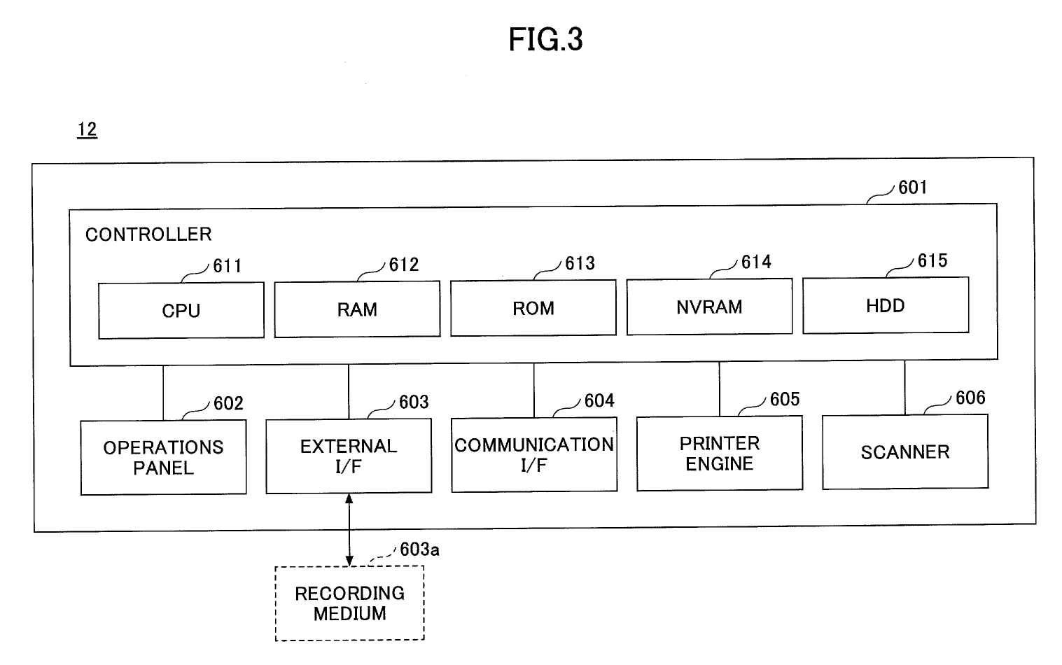

The image forming apparatus 12 depicted in FIG. 1 is implemented by a hardware configuration, such as that depicted in FIG. 3. FIG. 3 is a diagram illustrating a hardware configuration of an example of the image forming apparatus according to the embodiment. The image forming apparatus 12 of FIG. 3 is provided with a controller 601; an operations panel 602; an external I/F 603; a communication I/F 604; a printer engine 605; a scanner 606, etc.

The controller 601 includes a CPU 611; a RAM 612; a ROM 613; a nonvolatile random access memory (NVRAM) 614; a HDD 615, etc. The ROM 613 stores various types of programs and data. The RAM 612 temporarily stores a program and data. The NVRAM 614 stores, for example, configuration information, etc. The HDD 615 stores, for example, various types of programs and data.

The CPU 611 implements control and functions of the entire image forming apparatus 12 by reading out a program, data, configuration information, etc., from a storage device, such as the ROM 613, the NVRAM 614, and the HDD 615, onto the RAM 612 and by executing one or more processes.

The operations panel 602 is provided with an input unit for receiving an input by an operator; and a display unit for displaying an image. The external I/F 603 is an interface with an external device. Examples of the external device include a recording medium 603a. The image forming apparatus 12 is capable of reading out data from the recording medium 603a through the external I/F 603 and/or capable of writing data in the recording medium 603a through the external I/F 603. As examples of the recording medium 603a, there are an integrated circuit (IC) card, a flexible disk, a CD, a DVD, an SD memory card, a USB memory, etc.

The communication I/F 604 is an interface for coupling the image forming apparatus 12 to the network 16. The image forming apparatus 12 is capable of executing data communication through the communication I/F 604. The printer engine 605 is a printing device for printing print data on a conveyed object. The conveyed object may be, for example, a paper sheet, coat paper, cardboard, a plastic film, a prepreg, copper foil, etc. The conveyed object is not limited to a paper sheet. The scanner 606 is a reading device for reading image data (electronic data) from an original document.

<Software Configuration>

<<Information Processing Device>>

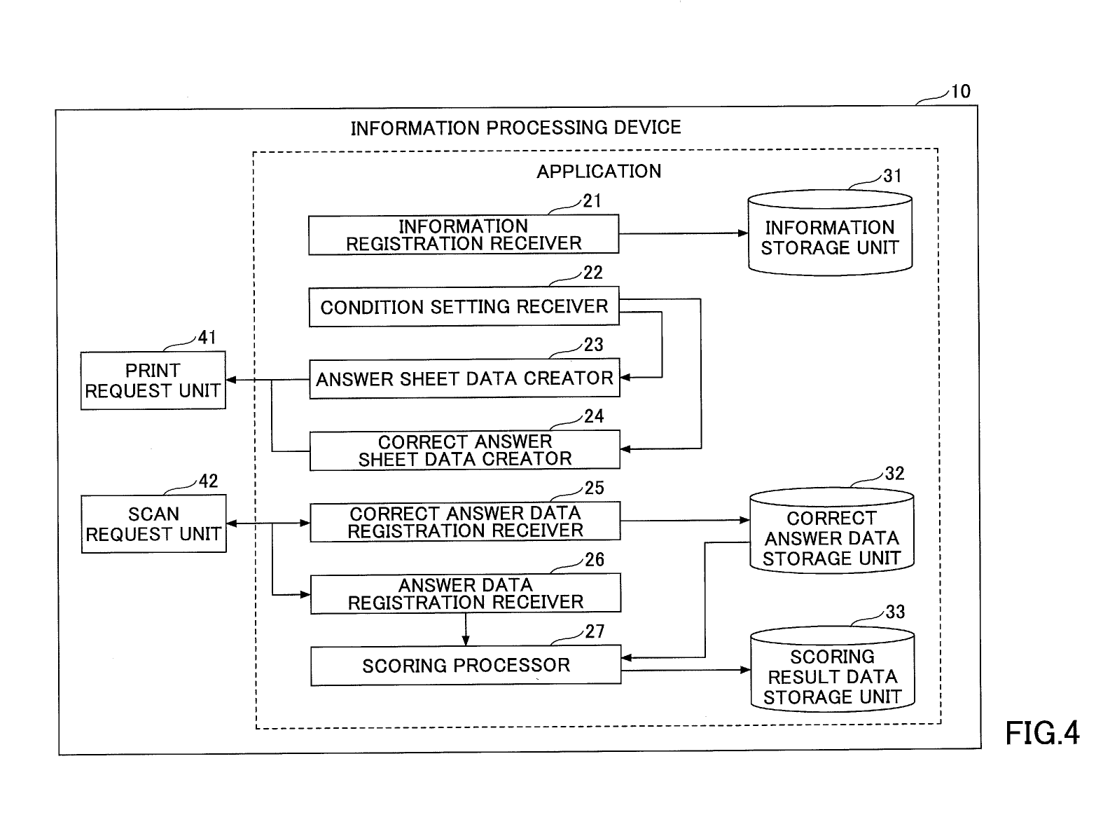

The software configuration of the information processing device 10 according to the embodiment is, for example, formed of the processing blocks depicted in FIG. 4. FIG. 4 is a diagram illustrating the processing blocks of an example of the information processing device 10 according to the embodiment. By executing, by the processor, one or more programs, the information processing device 10 implements, for example, the processing blocks depicted in FIG. 4.

The information processing device 10 of FIG. 4 implements an information registration receiver 21; a condition setting receiver 22; an answer sheet data creator 23; a correct answer sheet data creator 24; a correct answer data registration receiver 25; an answer data registration receiver 26; a scoring processor 27; an information storage unit 31; a correct answer data storage unit 32; a scoring result data storage unit 33; a print request unit 41; and a scan request unit 42. Note that, the information registration receiver 21; the condition setting receiver 22; the answer sheet data creator 23; the correct answer sheet data creator 24; the correct answer data registration receiver 25; the answer data registration receiver 26; the scoring processor 27; the information storage unit 31; the correct answer data storage unit 32; and the scoring result data storage unit 33. The print request unit 41 is implemented by print control software, such as a printer driver. The scan request unit 42 is implemented by scan control software, such as a scanner driver.

The information registration receiver 21 receives registration of class information, student information, and teacher information to store the class information, the student information, and the teacher information in the information storage unit 31. The condition setting receiver 22 receives a condition setting on an answer sheet, which is to be created as described below. The answer sheet data creator 23 creates, based on the condition setting on the answer sheet, a plurality of patterns of answer sheet data, which is described below. The correct answer sheet data creator 24 creates, based on the condition setting on the answer sheet, correct answer sheet data as described below.

The correct answer data registration receiver 25 causes the image forming apparatus 12 to scan a correct answer sheet in which correct answers are marked. The correct answer data registration receiver 25 receives the scan result as correct answer data to store the correct answer data in the correct answer data storage unit 32. After the test, the answer data registration receiver 26 causes the image forming apparatus 12 to scan an answer sheet in which the answers made by a student are marked. The answer data registration receiver 26 receives the scan result as answer data.

The scoring processor 27 compares the correct answer data stored in the correct answer data storage unit 32 with the answer data to execute scoring. Note that during comparison between the correct answer data and the answer data, the scoring processor 27 refers to a pattern of answer sheet data. The scoring processor 27 associates scoring result data with the student information to store the scoring result data and the associated student information in the scoring result data storage unit 33.

The information storage unit 31 stores the class information, the student information, and the teacher information. The correct answer data storage unit 32 stores the correct answer data. The scoring result data storage unit 33 stores the scoring result data. The print request unit 41 transmits a print request to the image forming apparatus 12. The scan request unit 42 transmits a scan request to the image forming apparatus 12.

<Description of the Answer Sheet in which Dummy Choices are Included in the Answer Mark Field>

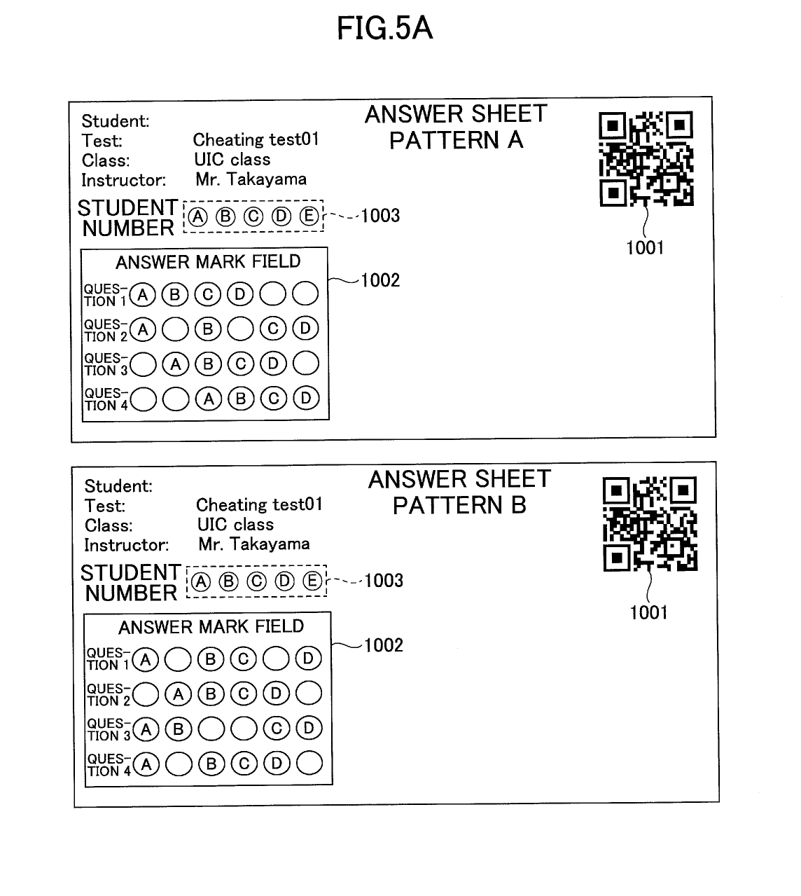

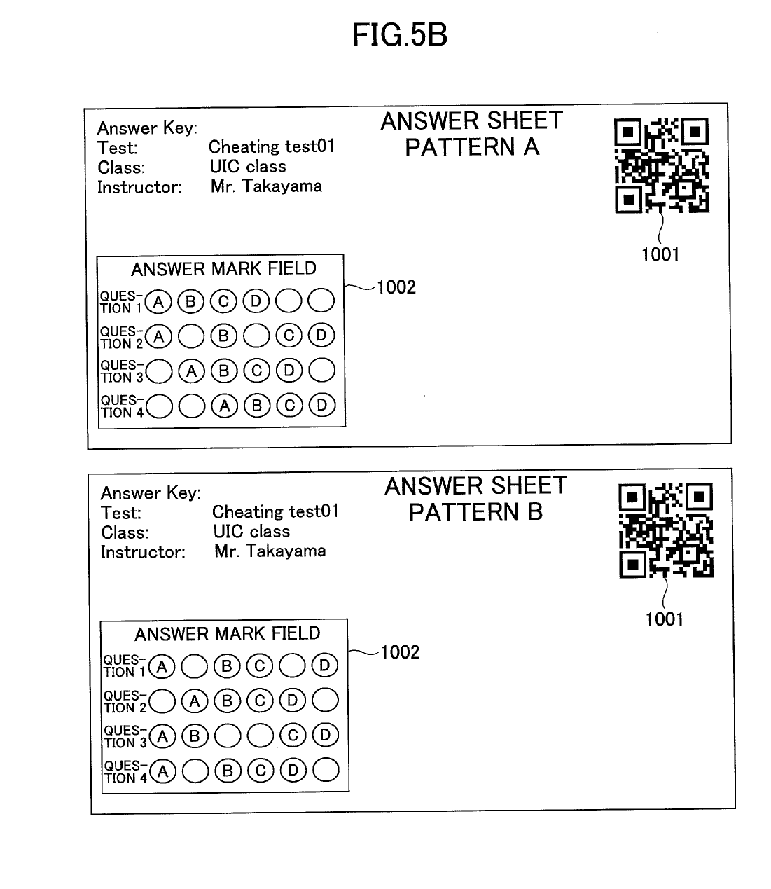

FIG. 5A and FIG. 5B are diagrams illustrating images of examples of the answer sheets and examples of the correct answer sheets. As depicted in FIG. 5A and FIG. 5B, a plurality of patterns of the answer sheets is prepared, and a plurality of patterns of the correct answer sheets is prepared (the answer sheet patterns A and B in FIGS. 5A and 5B). FIG. 5A depicts the plurality of patterns of the answer sheets. FIG. 5B depicts the plurality of patterns of the correct answer sheets. Each of the plurality of patterns of the answer sheets of FIG. 5A is an example of the answer sheet in which a student is to mark an answer in a test. Each of the plurality of patterns of the correct answer sheets of FIG. 5B is an example of the correct answer sheet in which a teacher is to mark a correct answer for the corresponding pattern.

In each of the answer sheets and the correct answer sheets of FIGS. 5A and 5B, a two-dimensional code 1001 is printed, in which answer sheet pattern information is embedded. Additionally, in each of the answer sheets and the correct answer sheets of FIGS. 5A and 5B, an answer sheet pattern name is printed, so that the answer sheet pattern name can be easily seen by a teacher and a student. Further, in each of the answer sheets and the correct answer sheets of FIGS. 5A and 5B, a test name, a class name, and a teacher name are printed. In each of the answer sheets of FIG. 5A, a student number mark field 1003 is provided in which a student is to mark a student number.

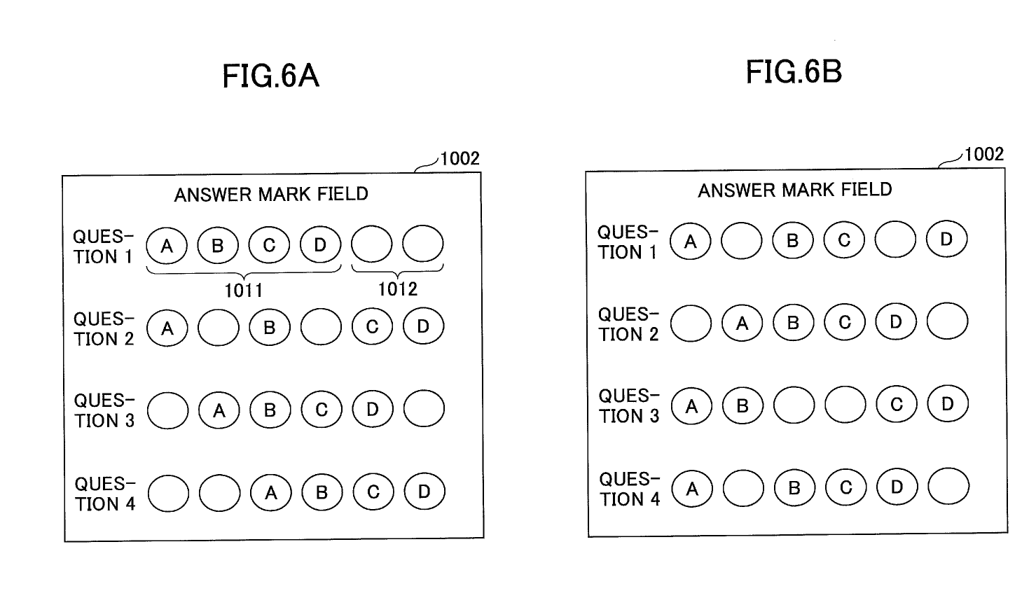

In each of the answer sheets and the correct answer sheets of FIGS. 5A and 5B, an answer mark field 1002 is provided that is different for each pattern. FIGS. 6A and 6B are diagrams illustrating examples of the answer mark field 1002 according to the embodiment. The answer mark field 1002 of FIG. 6A is a mark field of the answer sheet pattern A. The answer mark field 1002 of FIG. 6B is a mark field of the answer sheet pattern B.

In the answer mark field 1002 of each of FIG. 6A and FIG. 6B, for each question (questions 1 through 4), dummy choices 1012 are printed, in addition to the usual choices 1011. Here, the usual choices 1011 are choices in which correct answer candidates A, B, C, and D are printed, respectively. The dummy choices 1012 are choices other than the usual choices 1011. In FIGS. 6A and 6B, blank choices are depicted as examples of the dummy choices 1012; however, the dummy choices 1012 may be choices in which characters or symbols other than the correct answer candidates are printed, respectively.

As illustrated in FIGS. 6A and 6B, in the answer mark field 1002, insertion positions of the dummy choices 1012 with respect to the usual choices for one of the questions are different from insertion positions of the dummy choices 1012 with respect to the usual choices for another one of the questions. Additionally, for each question, insertion positions of the dummy choices 1012 with respect to the usual choices 1011 for one of the answer sheet patterns are different from insertion positions of the dummy choices 1012 with respect to the usual choices 1011 for another one of the answer sheet patterns.

For example, when the correct answer to the question 1 is “C,” the third choice from the left is the correct answer in the answer mark field 1002 in accordance with the answer mark sheet pattern A of FIG. 6A; and the fourth choice from the left is the correct answer in the answer mark field 1002 in accordance with the answer mark sheet pattern B of FIG. 6B. Accordingly, by alternatively distributing the answer sheets in accordance with the answer sheet pattern A of FIG. 6A and the answer sheets in accordance with the answer sheet pattern B of FIG. 6B between the odd row and the even row in a test center, even if a student furtively glances at the answers made by a neighboring student, with the positions of the marked choices, the student is unable to find the answers made by the neighboring student. As a result, according to the embodiment, a fraudulent act, such as cheating, can be prevented.

<Processing>

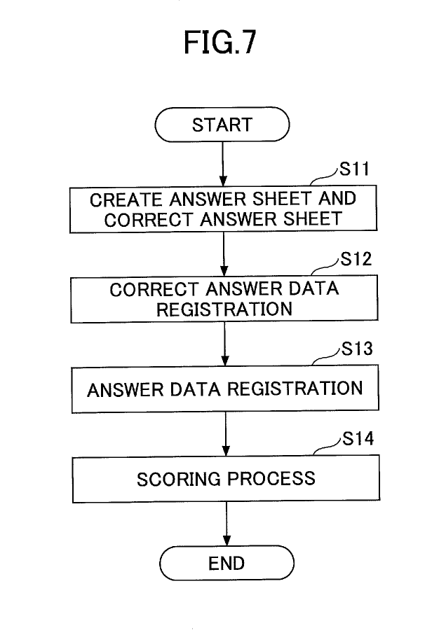

In the information processing system 1 according to the embodiment, preparation of the test and scoring after test are performed by a procedure, such as that illustrated in FIG. 7. FIG. 7 is a flowchart of an example of a process executed by the information processing system 1 according to the embodiment.

At step S11, for example, for each answer sheet pattern, a teacher creates an answer sheet and a correct answer sheet using the information processing system 1 according to the embodiment. At step S12, for each answer sheet pattern, the teacher marks the correct answers in the created correct answer sheet and scans the correct answer sheet in which the correct answers are marked using the image forming apparatus 12. For each answer sheet pattern, the scan result is registered with the information processing device 10 as correct answer data. Note that the process of step S12 may be performed prior to the test or after the test.

At step S13, after the test, the teacher scans, using the image forming apparatus 12, an answer sheet in which the answers made by a student are marked. The scan result is registered with the information processing device 10 as the answer data. At step S14, for each answer sheet pattern, the information processing device 10 executes scoring by comparing the correct answer data registered at step S12 with the answer data registered at step S13 while referring to the answer sheet pattern. The information processing device 10 stores the scoring result data while associating the scoring result data with the identification information of the student. The details of the process of steps S11 through S14 of FIG. 7 are described below.

<<Step S11: Creation of the Answer Sheet and the Correct Answer Sheet>>

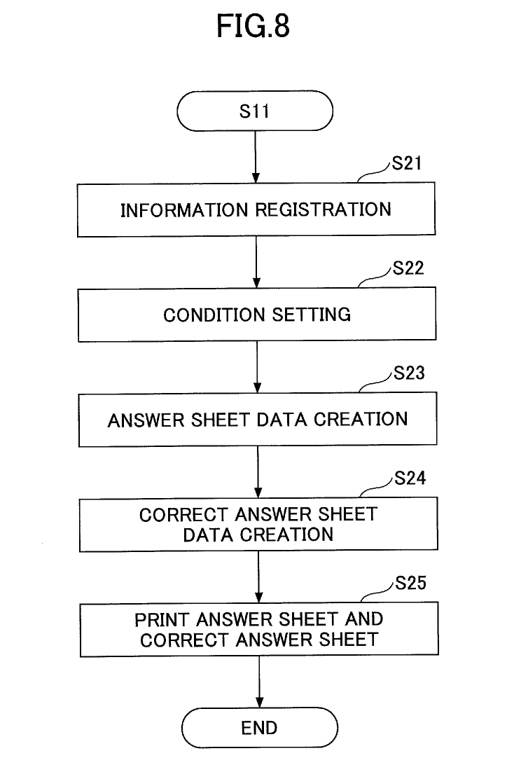

FIG. 8 is a flowchart of an example of a process related to creation of the answer sheet and the correct answer sheet. At step S21, a teacher registers information, such as class information, student information, and teacher information, with the information processing device 10. The information registration receiver 21 of the information processing device 10 receives the registration of the class information, the student information, and the teacher information from the teacher, and the information storage unit 31 stores the class information, the student information, and the teacher information.

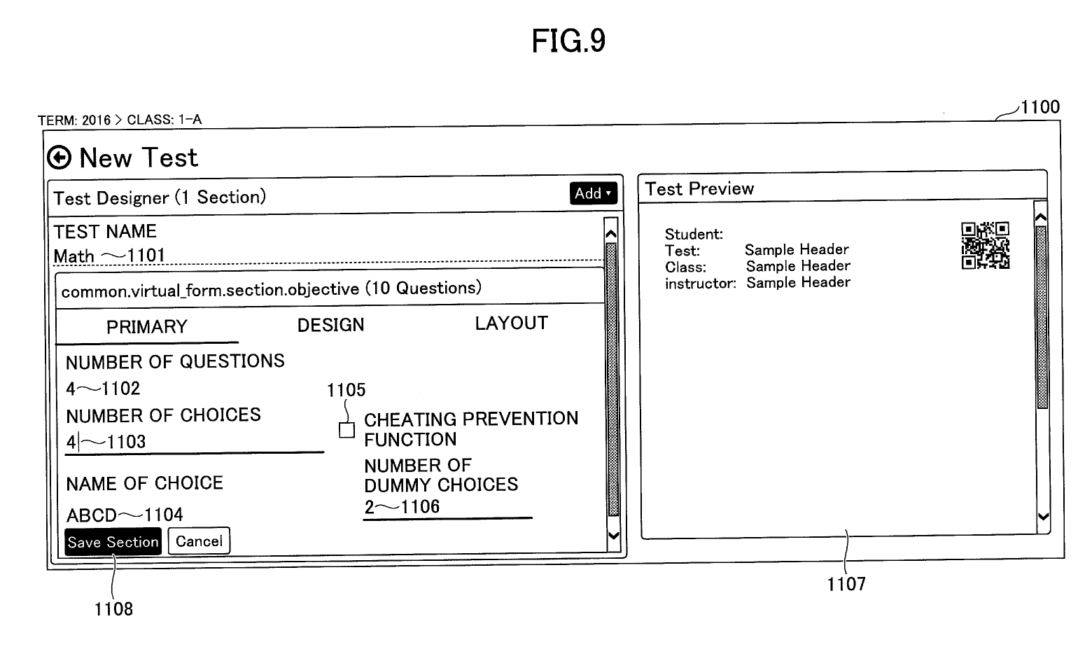

At step S22, the teacher causes the information processing device 10 to display a condition setup screen 1100 of FIG. 9, for example; and the teacher sets up conditions on the answer sheet to be generated. FIG. 9 is a diagram illustrating an image of an example of the condition setup screen 1100. The condition setting receiver 22 of the information processing device 10 receives condition setting from the condition setup screen 1100 for FIG. 9, for example.

In the condition setup screen 1100, a test name setting field 1101, a question number setting field 1102, a choice number setting field 1103, a choice name setting field 1104, a cheating prevention function ON/OFF setting field 1105, a dummy choice number setting field 1106, an answer sheet preview display field 1107, and a reflection button 1108 are displayed.

The question number setting field 1102 is a field for setting up a number of questions of a test. The choice number setting field 1103 is a field for setting up a number of choices for each question. The choice name setting field 1104 is a field for setting up correct answer candidates to be printed on the respective usual choices 1011 depicted in FIGS. 6A and 6B. The cheating prevention function ON/OFF setting field 1105 is a field for setting up ON/OFF of the cheating prevention function. When the cheating prevention function is turned on, the information processing device 10 creates answer sheet data of the answer sheet in which the answer mark field 1002 includes the dummy choices 1012, such as those depicted in FIGS. 5A and 5B. When the cheating prevention function is turned off, the information processing device 10 creates answer sheet data of the answer sheet in which the answer mark field 1002 does not include any dummy choice 1012. The dummy choice number setting field 1106 is a field for setting up a number of the dummy choices for each question.

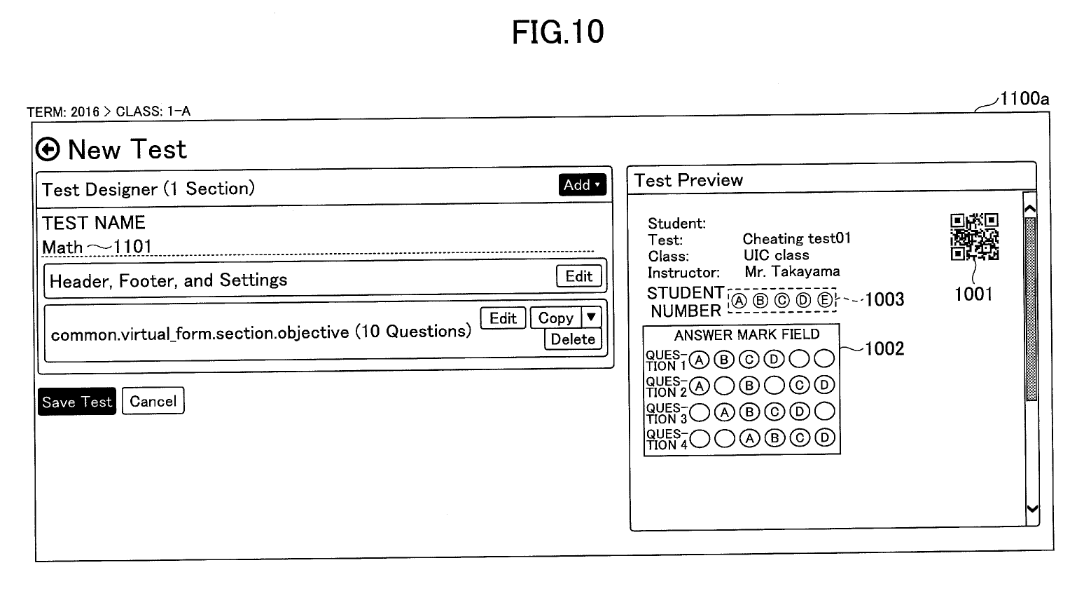

When the reflection button 1108 is pressed, an answer sheet preview corresponding to the details of the condition setting of the condition setup screen 1100 is displayed in the answer sheet preview display field 1107, as illustrated in FIG. 10, for example. FIG. 10 is a diagram illustrating an image of an example of the condition setup screen 1100, in which the answer sheet preview is displayed. The answer sheet preview of FIG. 10 is an example of a case in which the number of the questions and the number of the choices are set to “4,” the number of the dummy choices is set to “2,” and the choice name is set to “ABCD.” As described above, the teacher can set up conditions while checking the answer sheet preview displayed in the answer sheet preview display field 1107.

At step S23, the answer sheet data creator 23 of the information processing device 10 creates answer sheet data items corresponding to the plurality of answer sheet patterns based on the condition setting of the answer sheet. At step S24, the correct answer sheet data creator 24 of the information processing device 10 creates correct answer sheet data items corresponding to the plurality of answer sheet patterns based on the condition setting of the answer sheet.

At step S25, the print request unit 41 of the information processing device 10 prints the answer sheets for the number of students who take the test by using the answer sheet data items corresponding to the plurality of answer sheet patterns created at step S23. In the answer sheets printed at step S25, answer sheets corresponding to the plurality of answer sheet patterns are mixed. Further, print request unit 41 of the information processing device 10 prints correct answer sheets for the respective plurality of answer sheet patterns by using the correct answer sheet data items created at step S24. Here, the example is described in which the correct answer sheets for the respective plurality of answer sheet patterns are printed. However, as described below, when the correct answer sheets for all the respective answer sheet patterns in which the correct answers are marked are to be created from a single correct answer sheet for a single answer sheet pattern in which the correct answers are marked, the single correct answer sheet for the single answer sheet pattern may be printed.

<<Step S23: Creation of the Answer Sheet Data>>

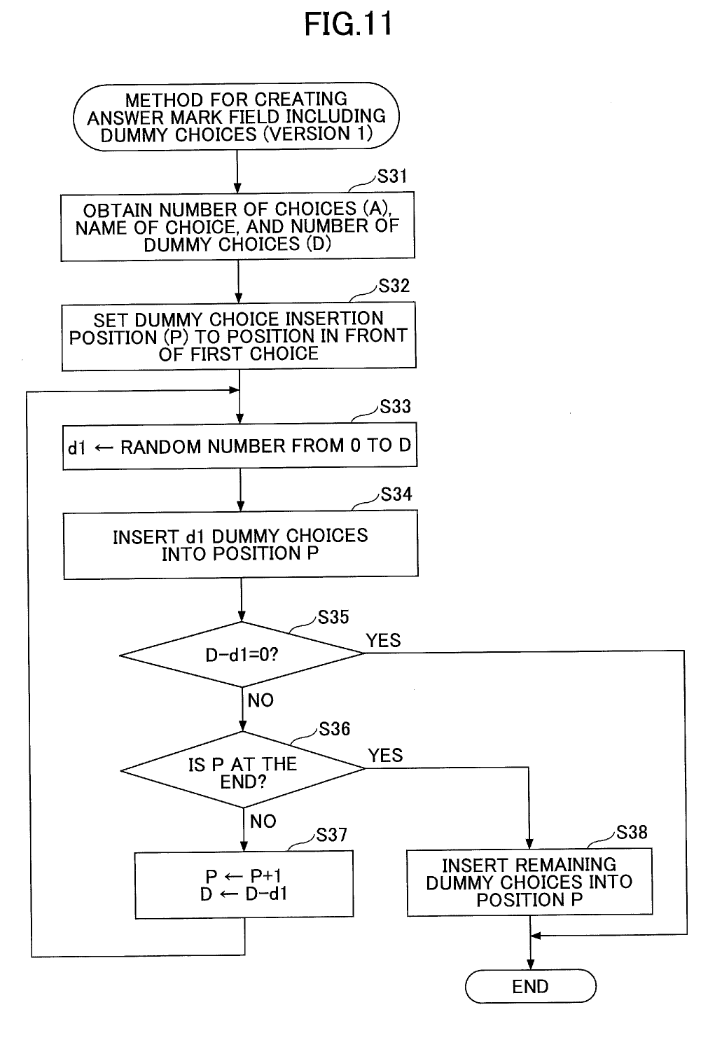

In the process of creating the answer sheet data items corresponding to the plurality of answer sheet patterns at step S23, the answer mark field 1002 including the dummy choices 1012 is created, for example, by the procedure illustrated in FIG. 11. Note that, the process of FIG. 11 is executed for each question.

FIG. 11 is a flowchart of an example of a process of a method for creating the answer mark field including the dummy choices (version 1). At step S31, the answer sheet data creator 23 of the information processing device 10 obtains, for example, the number of the choices (A), the choice name, and the number of dummy choices (D), which are set up, from the condition setup screen 1100 of FIG. 9.

At step S32, the answer sheet data creator 23 sets the insertion position (P) of the dummy choice 1012 to the position in front of the first choice 1011. At step S33, the answer sheet data creator 23 generates a random number in a range from 0 to D, and denotes the generated random number as d1. At step S34, the answer sheet data creator 23 inserts d1 dummy choices 1012 at the insertion position (P) of the dummy choice 1012.

At step S35, the answer sheet data creator 23 determines whether the number of the dummy choices (D)-d1 is equal to zero. Upon determining that the number of the dummy choices (D)-d1 is equal to zero, the answer sheet data creator 23 terminates the process of FIG. 11 because the insertion of all the dummy choices 1012 has been completed.

Upon determining that the number of the dummy choices (D)-d1 is not equal to zero, the answer data creator 23 determines, at step S36, whether the insertion position (P) of the dummy choice 1012 is at the end of the choices 1011. Upon determining that the insertion position (P) of the dummy choice 1012 is at the end of the choices 1011, the answer data creator 23 inserts, at step S38, all the remaining dummy choices 1012 at the end of the choices 1011, and terminates the process of FIG. 11.

Upon determining that the insertion position (P) of the dummy choice 1012 is not at the end of the choices 1011, the answer data creator 23 adds, at step S37, one to the insertion position (P) of the dummy choice 1012. Additionally, the answer data creator 23 subtracts d1 from the number of the dummy choices (D). Note that the process of adding one to the insertion position (P) of the dummy choice 1012 is a process such that the insertion position (P) of the dummy choice 1012 is moved by one position each time, from the position in front of the first choice 1011 toward the end of the choices 1011. The process of subtracting d1 from the number of the dummy choices is a process of calculating the number of the remaining dummy choices that are not inserted. After the process at step S37, the answer data creator 23 returns to step S33 and continues executing the process.

According to the method for creating the answer mark field including the dummy choices of FIG. 11, an answer mark field 1002 in which the dummy choices 1012 are randomly inserted among the usual choices 1011 can be easily created.

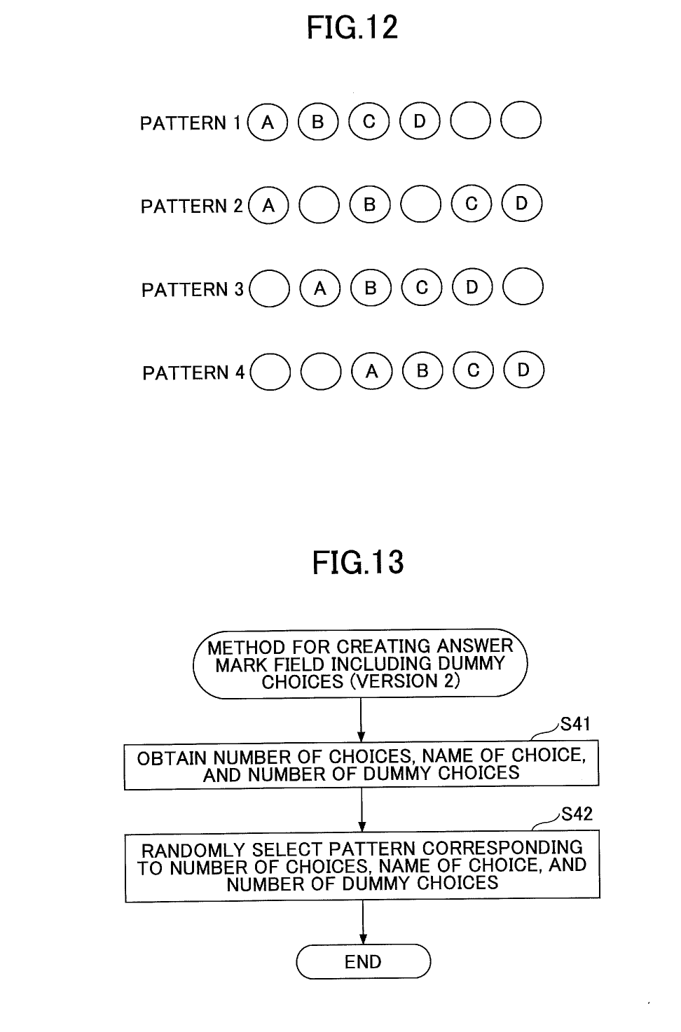

In the process of creating the answer sheet data items corresponding to the plurality of answer sheet patterns at step S23, an answer mark field 1002 including dummy choices 1012 may be generated as illustrated in FIG. 12 and FIG. 13, for example. FIG. 12 is a diagram of an image of an example of the patterns of the answer mark field that are stored for each combination of the number of choices and the number of dummy choices. FIG. 13 is a flowchart illustrating an example of a process of a method for creating the answer mark field including the dummy choices (version 2).

In the method for creating the answer mark field including the dummy choices (version 2), a plurality of insertion patterns corresponding to the number of choices, the choice name, and the number of the dummy choices is stored, in advance, in a storage area. FIG. 12 illustrates an example of a case in which the number of the choices is set to “4”, the number of the dummy choices is set to “2,” and the choice name is set to “ABCD.”

At step S41, the answer sheet data creator 23 of the information processing device 10 obtains the number of the choices (A), the choice name, and the number of the dummy choices (D), which are set up, from the condition setup screen 1100.

At step S42, for each question, the answer sheet data creator 23 randomly selects, from a plurality of insertion patterns, such as those of FIG. 12, an insertion pattern corresponding to the number of the choices (A), the choice name, and the number of the dummy choices (D) obtained at step S41.

By the method for creating the answer mark field including the dummy choices of FIG. 13, an answer mark field 1002 in which the dummy choices 1012 are randomly inserted among the normal choices 1011 can be easily created.

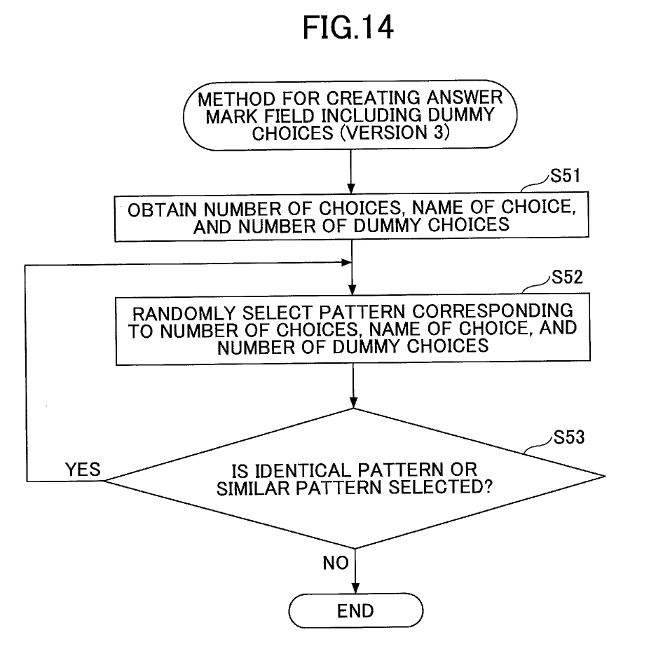

In the process of creating the answer sheet data items corresponding to the plurality of answer sheet patterns at step S23, an answer mark field 1002 including dummy choices 1012 may be generated by the procedure illustrated in FIG. 14, for example. FIG. 14 is a flowchart illustrating an example of a process of a method for creating the answer mark field including the dummy choices (version 3). Note that the method for creating the answer mark field including the dummy choices (version 3) is an improved version of the method for creating the answer mark field including the dummy choices (version 2).

At step S51, the answer sheet data creator 23 of the information processing device 10 obtains the number of the choices (A), the choice name, and the number of the dummy choices (D), which are set up, from the condition setup screen 1100.

At step S52, for each question, the answer sheet data creator 23 randomly selects, from a plurality of insertion patterns, such as those of FIG. 12, an insertion pattern corresponding to the number of the choices (A), the choice name, and the number of the dummy choices (D) obtained at step S51.

At step S53, the answer sheet data creator 23 compares the insertion pattern selected at step S52 with an insertion pattern of another answer sheet pattern for the same question to determine whether the identical or similar insertion pattern is selected.

For example, in the example of the insertion patterns of FIG. 2, if the insertion pattern of the other answer sheet pattern for the same question is “pattern 2,” and “pattern 2” or “pattern 4” is selected at step S52, a determination is made that the identical or similar insertion pattern is selected.

Upon determining that the identical or similar insertion pattern is selected, the answer sheet data creator 23 returns to step S52 and continues executing the process. Upon determining that an insertion pattern other than the identical or similar insertion pattern is selected, the answer sheet data creator 23 terminates the process illustrated in FIG. 14. Note that, by determining and processing to avoid selecting an insertion pattern that is identical or similar to an insertion pattern of the same answer sheet pattern for a previous question or an insertion pattern of the same answer sheet pattern for a subsequent question, the effect of the method for creating the answer mark field including the dummy choices (version 3) can further be enhanced.

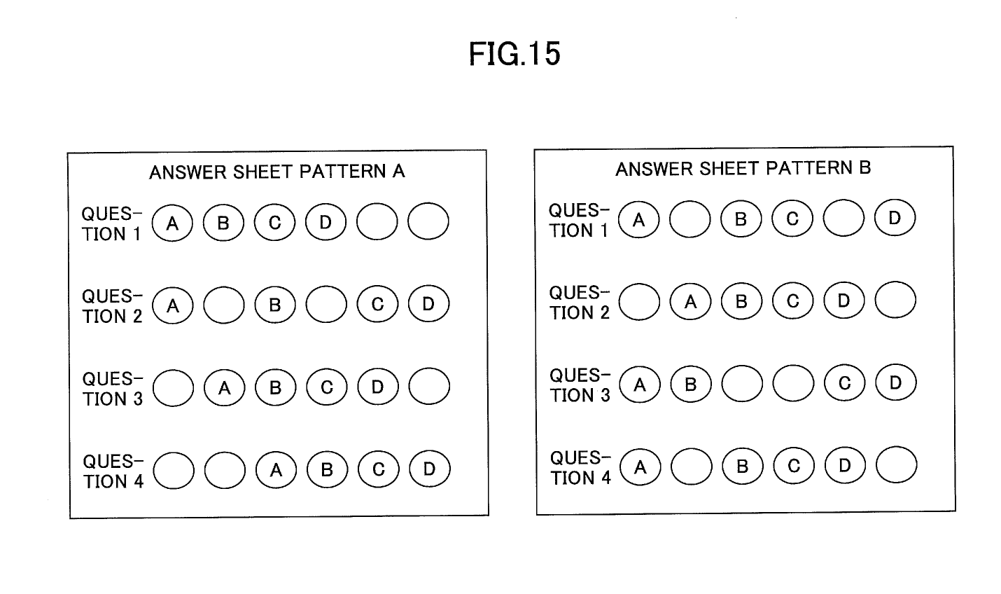

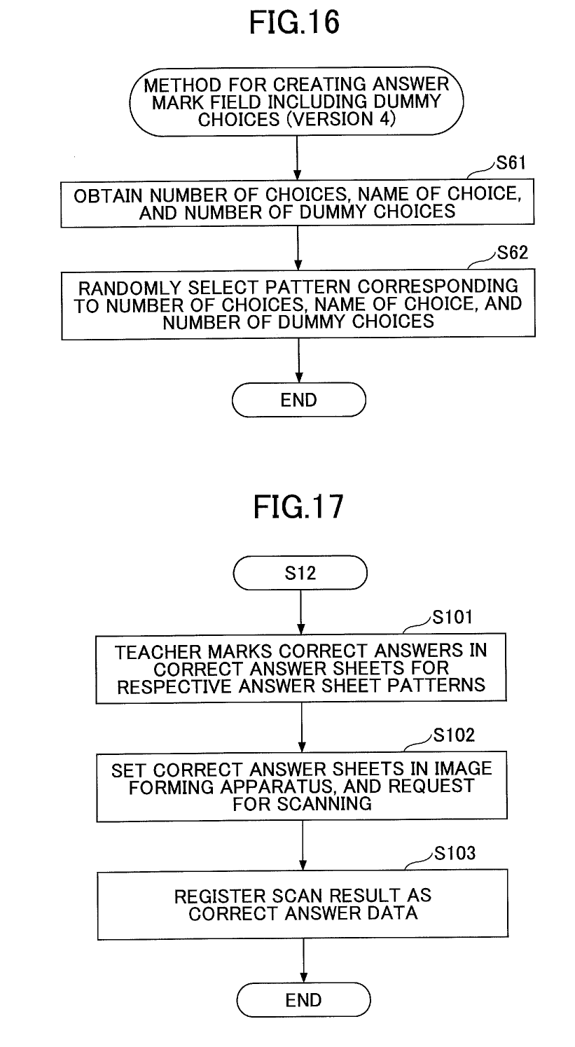

In the process of creating the answer sheet data items corresponding to the plurality of answer sheet patterns at step S23, an answer mark field 1002 including dummy choices 1012 may be generated as illustrated in FIG. 15 and FIG. 16, for example. FIG. 15 is a diagram of an example of answer sheet patterns that are stored for a combination of the number of the choices and the number of the dummy choices. FIG. 16 is a flowchart illustrating an example of a process of a method for creating the answer mark field including the dummy choices (version 4).

In the method for creating the answer mark field including the dummy choices (version 4), answer sheet patterns obtained by combining a plurality of insertion patterns corresponding to the number of the choices, the choice name, and the number of the dummy choices are stored, in advance, in a storage area. Note that FIG. 15 illustrates an example of a case in which the number of the choices is set to “4,” the number of the dummy choices is set to “2,” and the choice name is set to “ABCD.”

At step S61, the answer sheet data creator 23 of the information processing device 10 obtains the number of the choices (A), the choice name, and the number of the dummy choices (D), which are set up, from the condition setup screen 1100.

At step S62, the answer sheet data creator 23 randomly selects an answer sheet pattern corresponding to the number of the choices (A), the choice name, and the number of the dummy choices (D) obtained at step S61, for example, from a plurality of answer sheet patterns, such as those illustrated in FIG. 15.

According to the method for creating the answer mark field including the dummy choices of FIG. 16, an answer mark field 1002 in which dummy choices 1012 are randomly inserted among the usual choices 1011 can be easily created.

<<Step S12: Correct Answer Data Registration>>

FIG. 17 is a flowchart of an example of a process related to the correct answer data registration. At step S101, the teacher marks the correct answers on the correct answer sheets corresponding to the respective answer sheet patterns. At step S102, for each of the answer sheet patterns, the teacher sets the correct answer sheet on which the correct answers are marked on the image forming apparatus 12 and requests the correct answer data registration receiver 25 of the information processing device 10 for scanning.

At step S103, the scan request unit 42 of the image forming apparatus 12 requests the image forming apparatus 12 to scan. The image forming apparatus 12 scans, for each answer sheet pattern, the correct answer sheet on which the correct answers are marked and transmits the scan result to the correct answer data registration receiver 25 of the information processing device 10. The correct answer data registration receiver 25 stores the received scan result in the correct answer data storage unit 32 as the correct answer data.

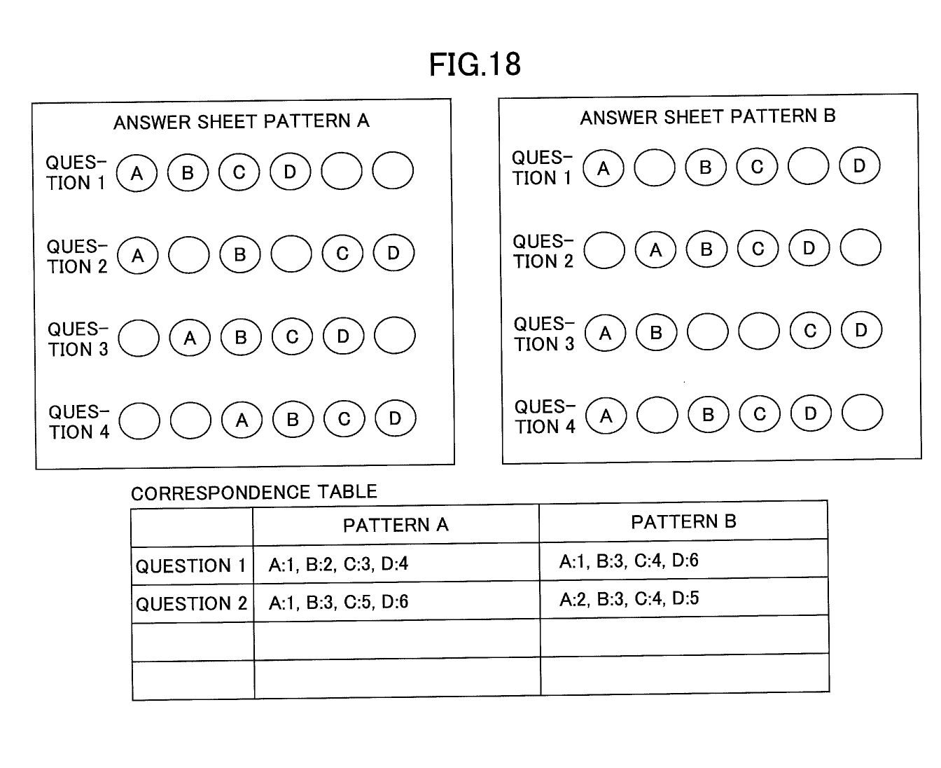

Note that, in the process related to the correct answer data registration at step S12, the correct answer sheets corresponding to all the answer sheet patterns in which the correct answers are marked can be created from a single correct answer sheet corresponding to a single answer sheet pattern in which the correct answers are marked, as described by referring to FIG. 18, for example.

FIG. 18 is a diagram illustrating an example of a process of registering, based on correct answers marked on a single correct answer sheet, correct answer data items corresponding to other answer sheet patterns. When the correct answer sheets corresponding to all the answer sheet patterns in which the correct answers are marked are to be created based on a correct answer sheet corresponding to one answer sheet pattern in which the correct answers are marked, a correspondence table is created that indicates, for each question, the positions of the normal choices, as illustrated in FIG. 18.

For example, the teacher marks the correct answers on the correct answer sheet corresponding to the “answer sheet pattern A,” and scans the correct answer sheet using the image forming apparatus 12. The scan result is registered with the information processing device 10 as the correct answer data for the “answer sheet pattern A.” By referring to the correspondence table of FIG. 18, the correct answer data registration receiver 25 can create the correct answer data for the “answer sheet pattern B” from the correct answer data for the “answer sheet pattern A.”

For example, in the example of FIG. 18, if, for the “question 1” of the correct answer sheet corresponding to the “answer sheet pattern A,” the second position from the left is marked, it can be determined, from the correspondence table, that the name of the choice of the correct answer is “B.” The correct answer data registration receiver 25 can determine, from the correspondence table, that the position at which the correct answer is to be marked for the “question 1” of the correct answer sheet corresponding to the “answer sheet pattern B” is the third position from the left.

Note that, by the same idea as the idea described by referring to FIG. 18, the correct answer sheets corresponding to all the answer sheet patterns can be generated from the correct answer sheet with the answer mark field 1002 not including any dummy choices 1012. In this case, it suffices if a correspondence table is created that indicates, for all the questions, the positions of the usual choices 1011 for the correct answer sheet with the answer mark field 1002 not including any dummy choices 1012 and for the correct answer sheets corresponding to all the answer sheet patterns.

<<Step S13: Answer Data Registration>>

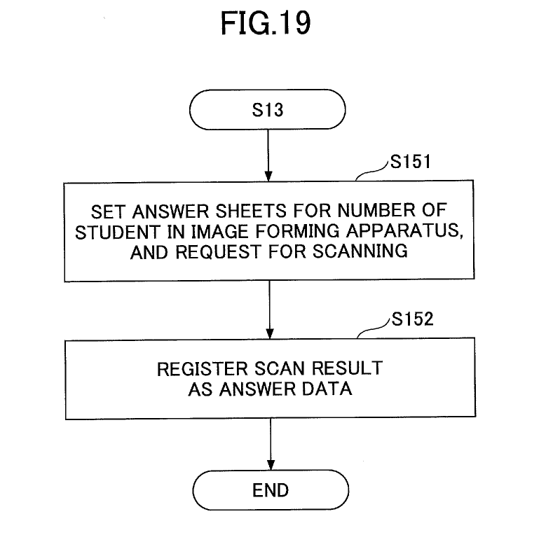

FIG. 19 is a flowchart of an example of a process related to the answer data registration. At step S151, the teacher sets, in the image forming apparatus 12, the answer sheets corresponding to the number of the students on which the answers made by the students are marked, and the teacher requests the answer data registration receiver 26 of the information processing device 10 for scanning.

At step S152, the scan request unit 42 of the image forming apparatus 12 requests the image forming apparatus 12 to scan. The image forming apparatus 12 scans the answer sheets on which the answers made by the students are marked, and the image forming apparatus 12 transmits the scan result to the answer data registration receiver 26 of the information processing device 10. The answer data registration receiver 26 registers the received scan result as the answer data.

<<Step S14: Scoring Process>>

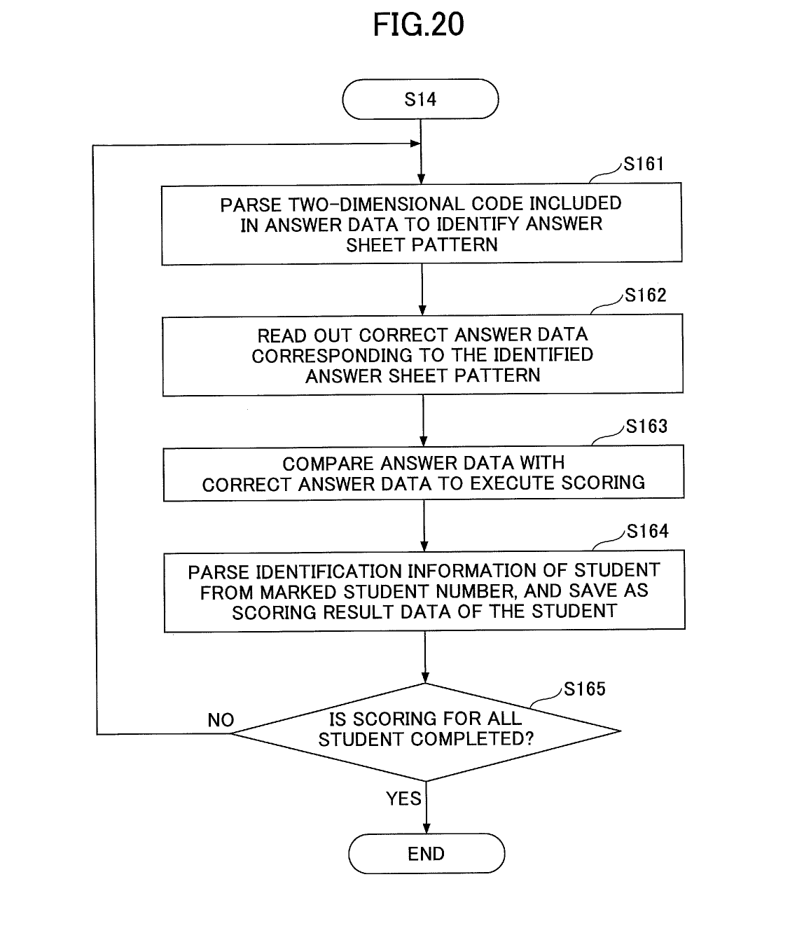

FIG. 20 is a flowchart of an example of a scoring process. At step S161, the scoring processor 27 of the information processing device 10 parses the two-dimensional code included in the answer data to find the answer sheet pattern. At step S162, the scoring processor 27 reads out, from the correct answer data storage unit 32, the correct answer data for the answer sheet pattern that is found at step S161.

At step S163, the scoring processor 27 compares positions of the marks in the answer data for which the two-dimensional code is parsed at step S161 with positions of the marks in the correct answer data read out at step S162 to execute scoring. Upon detecting that the position of the mark in the answer data for which the two-dimensional code is parsed at step S161 matches the position of the mark in the correct answer data read out at step S162, the scoring processor 27 determines that the correct answer is made for the question.

At step S164, the scoring processor 27 parses the identification information of the student from the marked positions in the student number mark field 1003 in the answer data for which the two-dimensional code is parsed at step S161, and the scoring processor 27 stores, in the scoring result data storage unit 33, the scoring result as the scoring result data of the student. The process from step S161 to step S164 are repeated until the scoring process for all the students is completed.

Note that, by changing the mark shape of the usual choice 1011 and the mark shape of the dummy choice 1012 to an extent that the difference is not visually confirmed, the scoring process at step S14 can be made as the following process. The correct answer data registration receiver 25 distinguishes between the usual choices 1011 and the dummy choices 1012 to detect the usual choices 1011 and the dummy choices 1012 in the image of the correct answer sheet, which is the scanning result; and the correct answer data registration receiver 25 stores the positions of the marks in a state in which the dummy choices 1012 are removed. Additionally, the answer data registration receiver 26 distinguishes between the usual choices 1011 and the dummy choices 1012 to detect the usual choices 1011 and the dummy choices 1012 in the image of the answer sheet, which is the scanning result; and the answer data registration receiver 26 registers the positions of the marks in a state in which the dummy choices 1012 are removed.

Accordingly, the scoring processor 27 is able to compare the positions of the marks in the answer data in which the dummy choices 1012 are removed with the positions of the marks in the correct answer data in which the dummy choices 1012 are removed to execute scoring. In this case, only one type of correct answer data may be stored in the correct answer data storage unit 32, regardless of the type of the answer sheet patterns.

Further, by providing a function to detect a name of the choice printed on the usual choice 1011, such as a letter of an alphabet, the scoring process at step S14 can be made as the following process. The correct answer data registration receiver 25 detects the name of the choice at the position of the mark from the image of the correct answer sheet, which is the scanning result, to store the name of the choice. Additionally, the answer data registration receiver 26 detects the name of the choice at the position of the mark from the image of the answer sheet, which is the scanning result, to register the name of the choice.

Accordingly, the scoring processor 27 is able to compare the names of the choices that are marked for the same question and detected from the correct answer sheet and the answer sheet to execute scoring. In this case, the correct answer data storage unit 32 may store only one type of the correct answer data, regardless of the types of the answer sheet patterns.

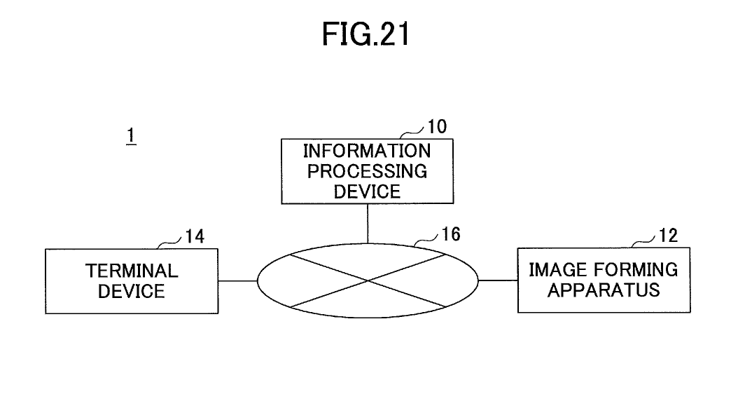

The present invention is not limited to the specifically disclosed embodiments, and various modifications and alterations may be made without departing from the scope of the claims. For example, the configuration of the information processing system 1 may be a configuration illustrated in FIG. 21. FIG. 21 is a diagram illustrating a configuration of another example of the information processing system 1 according to the embodiment.

The configuration of the information processing system 1 of FIG. 21 is obtained by adding a terminal device 14 to the configuration of the information processing system 1 of FIG. 1. In the information processing system 1 of FIG. 21, the processing blocks of the information processing device 10 of FIG. 4 are distributed between the information processing system 10 and the terminal device 14. According to the information processing system 1 of FIG. 21, for example, the function according to the embodiment can be provided as a cloud service. As described above, the configuration of the information processing system 1 according to the embodiment is merely an example, and there are various system configuration examples depending on an application or an object.

Further, when, for example, the information processing system 1 according to the embodiment is to be used for a questionnaire, the scoring process at step S14 may not be required. Even if the scoring process is not required, the answer sheet according to the embodiment is beneficial from the perspective of privacy protection, as a respondent can be protected from cheating.

The present application is based on and claims the benefit of priority of Japanese priority application No. 2017-035164 filed on Feb. 27, 2017, the entire contents of which are hereby incorporated herein by reference.

What is claimed is:

1. An information processing device for creating a data item of an answer sheet, wherein the answer sheet is used for a respondent to select an answer to a question from a plurality of choices, the information processing device comprising:
a processor; and
a memory that stores a program which causes the processor to execute the following steps:
creating the data item of the answer sheet including an answer field for each question, based on a number of a first choices that are answer candidates to the question and a number of one or more second choices that are choices other than the answer candidates to the question, wherein the answer field for each question is arranged by inserting the one or more second choices in one or more positions, each one or two of the one or more positions being adjacent to the corresponding first choice of the first choices; and
creating one or more data items of respective one or more answer sheets by changing the one or more insertion positions of the one or more second choices for the same question.

2. The information processing device according to claim 1, wherein the steps executed by the processor further include:
creating, for each of a plurality of types of answer sheets created by changing, for the same question, the one or more insertion positions of the one or more second choices, data of a correct answer sheet that is used for an operator to register one of the first choices as a correct answer, wherein the data of the correct answer sheet is such that the one or more insertion positions of the one or more second choices are identical to the one or more insertion positions of the one or more second choices in the type of the answer sheet; and
executing scoring by causing an image forming apparatus to read the type the answer sheet and the correct answer sheet created for the type of the answer sheet, and by comparing, for the same question, a position of one of the first choices selected by the respondent with a registered position of the correct answer that is registered by the operator.

3. The information processing device according to claim 1, wherein the steps executed by the processor further include:
receiving, from an operator, a condition setting including a number of the questions, the number of the first choices, and the number of the one or more second choices.

4. The information processing device according to claim 1, wherein the steps executed by the processor further include:
changing the one or more insertion positions of the one or more second choices by using one or more random numbers.

5. The information processing device according to claim 1, the steps executed by the processor further include:
changing the one or more insertion positions of the one or more second choices by reading out, based on a random number, one type of a plurality of types of the one or more insertion positions of the one or more second choices corresponding to the number of the first choices and the number of the one or more second choices from a storage unit storing the plurality of types of the one or more insertion positions of the one or more second choices corresponding to the number of the first choices and the number of the one or more second choices.

6. The information processing device according to claim 5, wherein the steps executed by the processor further include:
upon detecting that there are two or more types of the answer sheets in which the one or more insertion positions of the one or more second choices for the same question are identical or similar, reading out again, from the storage unit, the one or more insertion positions of the one or more second choices corresponding to the number of the first choices and the number of the one or more second choices.

7. The information processing device according to claim 1, wherein the steps executed by the processor further include:
changing the one or more insertion positions of the one or more second choices by reading out, based on a random number, one type of the data of the answer sheet from a storage unit storing a plurality of types of data items of the answer sheets, wherein each of the data items of the answer sheets is obtained by combining a plurality of types of the one or more insertion positions of the one or more second choices corresponding to the number of the first choices and the number of the one or more second choices.

8. The information processing device according to claim 2, wherein the steps executed by the processor further include:
using a correspondence table indicating positions of the first choices for each of a plurality of types of the answer sheets generated by changing, for the same question, the one or more insertion positions of the one or more second choices so as to generate, from registered positions of the first choices that are correct answers read by the image forming apparatus from one type of the correct answer sheet, another type of the correct answer sheet.

9. A non-transitory computer program product for being executed on a computer, comprising:
computer readable program that causes the computer to
creating a data item of an answer sheet including an answer field for each question, based on a number of a first choices that are answer candidates to the question and a number of one or more second choices that are choices other than the answer candidates to the question, wherein the answer field for each question is arranged by inserting the one or more second choices in one or more positions, each one or two of the one or more positions being adjacent to the corresponding first choice of the first choices; and
creating one or more data items of respective one or more answer sheets by changing the one or more insertion positions of the one or more second choices for the same question.

10. An information processing system including an information processing device and a printing apparatus, the information processing device comprising:
a processor; and
a memory that stores a program which causes the processor to execute the following steps:
creating a data item of an answer sheet including an answer field for each question, based on a number of a first choices that are answer candidates to the question and a number of one or more second choices that are choices other than the answer candidates to the question, wherein the answer field for each question is arranged by inserting the one or more second choices in one or more positions, each one or two of the one or more positions being adjacent to the corresponding first choice of the first choices; and
creating one or more data items of respective one or more answer sheets by changing the one or more insertion positions of the one or more second choices for the same question,
wherein the printing apparatus comprising a print engine that prints the answer sheets based on the created data items of the answer sheets.

11. An information processing method executed by a computer by executing the non-transitory computer program product according to claim 9.
